(19) United States
(12) Patent Application Publication
(10) Pub. No.: US 2003/0193482 A1
(43) Pub. Date: Oct. 16, 2003

(54) Touch pad system

(76) Inventor: Yongsun Kim, Kyunggi-do (KR)

Correspondence Address: GREENBLUM & BERNSTEIN, P.L.C., 1950 ROLAND CLARKE PLACE, RESTON, VA, 20191, US

(21) Appl. No.: 10/333,903

(22) PCT Filed: Aug. 1, 2001
(86) PCT No.: PCT/KR01/01307

(51) Int. Cl. G09G 5/00

(52) U.S. Cl. 345/173

(57) ABSTRACT

The present invention relates to a touch pad system by which a shape and movement of an object can be transmitted and realized in real time through communications. When using communication means such as the internet, the touch pad system according to the present invention perceives information on an object, such as contact pressure, shape and temperature of the object, which comes into contact with a pad referred to as “touch pad” and exerts the pressure on the touch pad, from a computer, by using the touch pad connected to the computer. Further, the touch pad system transmits the information to a computer of the other party so that the shape and movement of the object can be transmitted to and realized in the computer of the other party, in real time, according to signals received in the touch pad of the other party. Thus, upon mutual communications, a feeling of touch can be experienced. According to the touch pad system of the present invention, there is an advantage in that in addition to viewing scenes displayed on a monitor screen, an environment capable of experiencing the feeling of touch due to the contact with the object can be provided by mutually transmitting the shape and movement of the object.

### TECHNICAL FIELD

This invention relates to the touch pad system, which enables the user to feel a shape and movement of an object and furthermore touch of skin contact between the users by communication.

### BACKGROUND TECHNOLOGY

Existing communication means and units just depended on audio/visual mode like video, picture file, music file to transmit message from the source to the receiver.

Under this condition, real-time transmission of a shape and touch has problems totally different from existing technologies.

### DETAILS OF THE INVENTION

To solve this problem, this invention is to provide the touch pad system to transmit and implement real-time a shape and movement of an object to contact on the touch pad of the remote computer as well as to provide information by audio/visual mode, and ultimately feel each other skin touch by transmitting and receiving mutual information interactively.

### Problem to be Solved

To achieve the above object, this invention provided the touch pad system, which is composed of the touch pad contact surface(20) and the contact-sensing signal transmitting and receiving part to sense pressure signal from the pressure sensor attached on the touch pad contact surface(20) and transmit it to the central control part(60); the cell position sensing part(50) to sense up/down position changes of each cell(7) positioned on the lower part of the touch pad contact surface(20) and the central control part(60) to transmit signal and input data of the contact-sensing signal transmitting and receiving part(10) and the cell position sensing part(50) through the computer system by communication like Internet to the remote computer system(80), receive input data of the remote computer system(80), process the data according to embedded program, and control the pressure signal control part(40) and the contact-sensing signal transmitting and receiving part(10); the pressure signal controlling part(40) to receive pressure signal received from the central control part(60) and transfer it to the pressure implementation enabling part(30) installed at the bottom of each cell unit; and the pressure implementation enabling part(30) to generate pressure for the user to sense touch interactively from a shape or movement of a shape on the touch pad contact surface(20) in response to pressure signal of the pressure signal controlling part(40), receive the pressure signal of the user and transmit it to the pressure signal controlling part(40).

### SUMMARY OF DRAWINGS

FIG. 1, as an outline diagram, illustrates the touch pad system by a working example of desirable hydraulic and pneumatic type in this invention;

FIG. 2, as a plan, illustrates cells of the touch pad cells in this invention;

FIG. 3, as a simple diagram, illustrates the pressure implementation enabling part of the touch pad system as hydraulic and pneumatic type in this invention;

FIG. 4, as a block diagram, illustrates the signal transmitting part of the touch pad system by other working example in this invention;

FIG. 5, as a block diagram, illustrates the signal-sensing implementing part of the touch pad system by other working example in this invention;

FIG. 6, as a simple figure, illustrates with magnification the connection between the pressure implementing bar of hydraulic and pneumatic type and the cell of the touch pad system in this invention;

FIG. 7, as a simple diagram, illustrates the connection between the pressure implementing bars and the cells of the pressure implementation enabling part of hydraulic and pneumatic type of the touch pad system in this invention;

FIG. 8, as a whole design drawing, illustrates the touch pad system of hydraulic and pneumatic type by a working example in this invention;

FIG. 9, as a simple drawing, illustrates the pressure implementation enabling part of magnetic type by a desirable working example of the touch pad system in this invention;

FIG. 10, as an example drawing, illustrates the touch pad system in this invention measures position data of cells and converts them into data, which can be recognized by the computer;

FIG. 10, as a block diagram, illustrates the data transmitting unit to transmit data of the touch pad system to sense touch in this invention;

FIG. 12, as a block diagram, illustrates operating environment of a computer communication model to transmit data of the touch pad system to sense touch in this invention; and

FIG. 13, as a block diagram, illustrates the whole architecture of the OSI(Open System Interconnection) model among computer communication models to transmit data of the touch pad system to sense touch in this invention.

### DESCRIPTION OF MARKS ON MAJOR PARTS OF EACH FIGURE

7: Cell—As small size and plural, it implements a shape of an object;

10: Contact-sensing signal transmitting and receiving part—it senses and transmits contact signal of an object to contact on the touch pad contact surface(20), and if possible, receives signal from the central control part;

20: Touch pad contact surface—It is positioned on the top of the touch pad cells, covers them, and was made enabling sensors including pressure sensor to sense signal of a contact object to be attached;

30: Pressure implementation enabling part—It implements a shape by putting pressure upon each cell according to the received signal and has several types of hydraulic and pneumatic type or magnetic type;

40: Pressure signal controlling part—It converts the received signal via the central control part(60) into pressure signal—signal suitable for hydraulic and pneumatic type or electromagnetic type—and transmits it to the pressure implementation enabling part(30).

50: Cell position sensing part—It senses up/down movement position of the touch pad cells(7) with the sensor and transmits it to the central control part(60). If the pressure implementation enabling part(30) is magnetic type, it also senses and transmits position of the electromagnet(A102).

60: Central control part—It embeds the contact-sensing signal transmitting and receiving part(10), the cell position sensing part(50), and the pressure signal controlling part(40), processes and wholly controls transmission and reception through the recorded program saving medium. Also, it transmits and receives signal to the remote computer(80) via the communication part of the computer(70).

A102: Electromagnet—It generates magnetic force by received signals.

A103: Spring—It contracts and falls with the internal electromagnet support bar(A105) according to pressure that is put upon the resistance object of the cell on the top, and then returns to the original state.

A105: Electromagnet support bar—It is connected to the inside of the spring(A103) in the electromagnet, inserted into the support(2), falls according to pressure that is put upon the cell(7), and then returns to the original state of spring force.

A106: Sensor-installed hole—It is equipped with the pressure sensor and the position and displacement sensor, installed in the support(2) for either hydraulic and pneumatic type or magnetic type, and if necessary, the position may be changed.

A200: Resistance object—It is all-in-one with the cell, rises from the electromagnet when magnetic force occurs in the electromagnet(A102), and is composed of permanent magnet or superconductor.

A300: Magnet and resistance object deviation-preventing tube

### Working Example

In this invention, the omnibus composition is named touch pad system. It is composed of user's PC, touch pad installed in the PC, touch pad control program embedded in the PC, computer in a remote place, which is connected by Internet with it, and touch pad and program embedded and installed in the computer. Touch pad calls generally a unit to be installed in the outside of the computer including pressure bulb suspension edge and cell(7), which will be touched by the user, and the touch pad interface to cover the top. This touch pad system has largely two functions to achieve the object; first, converting the movement of the contact of an object that touches the touch pad interface(20) and presses on the touch pad into a signal and transmitting it; second, contrary to the first, receiving the signal from the computer attaching the touch pad system in a remote place, converting the received information again and implementing shape and movement of the object. Hereafter, the composition of this invention is described in detail by referring to the attached drawings with the desired working examples.

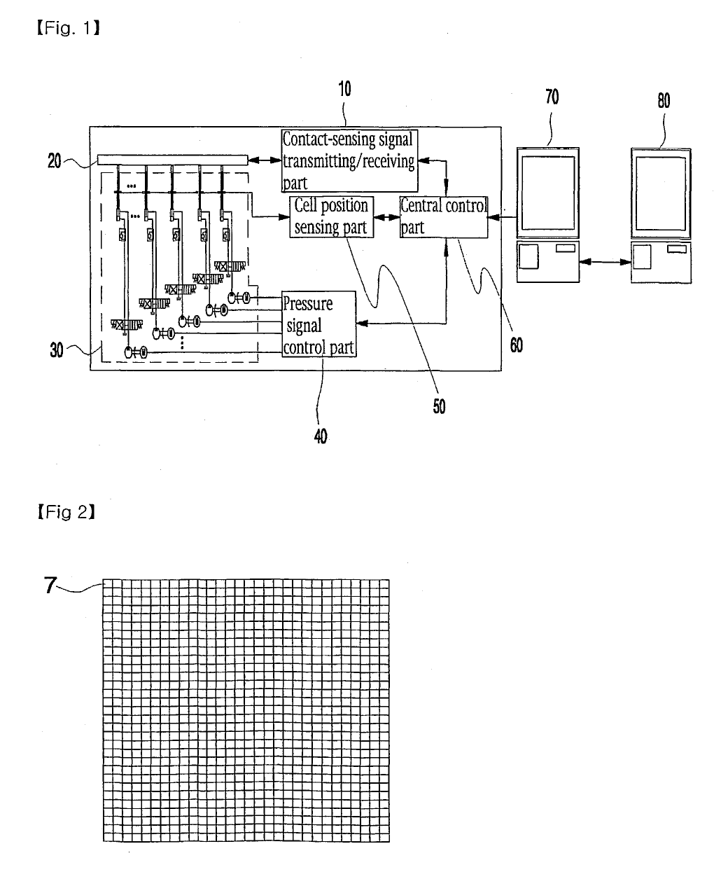

As illustrated in FIG. 1, this invention, the touch pad system is composed of the touch pad cells(7) consisting of small cells with certain size, the touch pad contact surface on the top of the touch pad cells(7), the contact-sensing signal transmitting and receiving part(10) to sense and transmit pressure signal from the pressure sensor attached on the touch pad contact surface(20), the pressure implementation enabling part(30) connected to the bottom of the touch pad cells(7) to implement pressure, the cell position sensing part(50) to sense up/down position data and pressure of the touch pad cells(7), which were sensed in the cell position and displacement sensor(A106) and the pressure sensor(A106) on the support(2) of the pressure implementation enabling part(30), and transmit them to the central control part(60), the central control part(60) to receive and control signal of the cell position sensing part(50) and the contact-sensing signal transmitting and receiving part(10) and also control signal received from the remote computer touch pad system(80), and the pressure signal controlling part(40) to emit the pressure signal received from the central control part(60) to the pressure implementation enabling part(30) installed on the bottom of each cell unit.

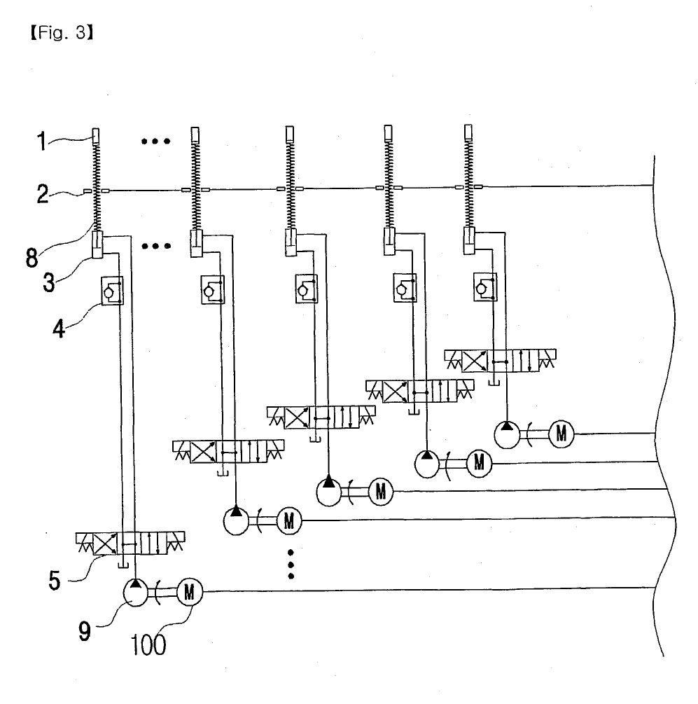

The touch pad contact surface(20) has smooth material on the surface covering the top of the touch pad cells(7) to facilitate transmission of touch sense, and the bottom of the touch pad contact surface(20) changes the shape and returns to the original state according to contact pressure to facilitate transmission of touch sense, and is composed of the touch pad cells(7) as illustrated in FIG. 2, which the contact is divided and calculated into small-size unit—a theory like that picture data of a digital picture is expressed into small-unit dots. The pressure sensor is attached to the touch pad contact surface(20) covering the touch pad cells(7), which is on the top of each touch pad cell(7), and senses pressure signal of an object to contact the touch pad contact surface(20) and transmit it to the contact-sensing signal transmitting and receiving part(10). The pressure sensor is attached to each touch pad cell(7), and if necessary, installed at the lower part of the support(2) of the touch pad cell(7). In this invention, the pressure sensor of the touch pad contact surface(20) plays a role of sensing the initial contact pressure and then inducing smooth operation of the system. The pressure sensor installed to sense to each cell in the support(2) senses pressure of each touch pad cell(7) more finely. The contact-sensing signal transmitting and receiving part(10) transmits signal generated and received from the pressure sensor that senses pressure information of each object to contact on the touch pad contact surface(20) to the central control part(60). If detail information implementation of a contact object is needed, attachment of several sensors including pressure sensor, heat sensor and flexibility sensor is recommended to sense and transmit signal, convert it again and then implement it close to the real shape.

The touch pad cell(7) is divided into small-size units, and the less the size is, the more detail information can be implemented. For instance, to sense finely a shape of an object to contact and put pressure on the touch pad contact surface(20), each cell(7) have each shape and sense and transmit information including a shape and movement of an object to contact on the touch pad contact surface(20) by moving up/down according to uneven part of a shape of an object, and the lower part of each cell(7) is connected to each cell as the pressure implementation enabling part(30). On the other hand, several cells are gathered and implement a shape and movement of an object according to the received signal by means to move each cell(7) up and down for the signal received from the remote computer(80).

The central control part(60) transmits input data to the remote computer touch pad system(80) by communication means like Internet through the user computer system(70), and in this case, it can go through SW of the central control server, which is programmed and embedded. On the other hand, it enables mutual data exchange that signal is received from the remote computer touch pad system(80), and the central control part(60) of the remote computer touch pad system(80) implements the received data on the touch pad contact surface(20) of the remote computer(80) through the pressure implementation tool part(30) on the remote computer side. This signal transmission and reception enables information to be interactively implemented unidirectionally or bidirectionally through the touch pad. As data communication is always bidirectional, when pressure is put upon the touch pad at the same time with the remote computer, in what side pressure was put upon more can be controlled by calculating collision of mutual forces. It is expressed numerically as follows;

If the touch pad is used both in the A side(70) and B side(80), when force 100N applied from the touch pad system in the A side is less than force 200N in the B side, the touch pad operates plus 100N to the touch pad system in the A side.

If force 200N applied from the touch pad system in the A side is over force 100N in the B side, the touch pad operates plus 100N to the touch pad system in the B side. When force 200N applied from the touch pad system in the A side is equal to force 200N in the B side, same force is collided, so both sides do not operate.

The pressure signal controlling part(40) responses to the pressure signal received from the remote computer system(80) then the central control part(60) and transmits it to the pressure implementation enabling part(30, and controls pressure signals of each cell(7) to implement the received data. For a trouble incurred from sharp changes in pressure given to the cells(7), if the implementing means of the pressure implementation enabling part(30) is pneumatic and hydraulic type, smooth operation of the cylinder is controlled through the pressure signal controlling part(40) and the pressure implementation enabling part(30), and if it is electromagnetic type, sharp changes in voltage is controlled through the pressure signal controlling part(40) and the pressure implementation enabling part(30) for smooth operation.

The cell position sensing part(50) senses position data and pressure, which were caused by rise or fall or the pressure implementing bar(1) allotted for each cell in the position and displacement sensor(A106) and the pressure sensor(A106) installed in the support(2) of the pressure implementation enabling part(30) connected to each cell(7), and transmits the data to the central control part(60).

As shown in FIG. 3, the pressure implementation enabling part(30), for hydraulic and pneumatic type in response to pressure signal of the pressure signal controlling part(40), it is composed of the pressure transmitting pump(9) to convert the pressure transmitting medium like oil or air into proper pressure and transmit it to the cylinder(3) alloted to each cell, the motor(100) to drive the pressure transmitting pump(9), the solenoid valve(5) to adjust flow of the pressure transmitting medium drawn from the pressure transmitting pump(9) according to pressure signal and transfer to the cylinder, the cylinder(3) to operate by transmission of the pressure transmitting medium to be transferred from the solenoid vale(5), the flow control valve connected to the rod side of the cylinder(3) to prevent sharp changes in loads by putting back pressure onto the rod side, the pressure implementing bar(1) connected to the piston of the cylinder(3) and allotted to each cell to implement some pressure, the spring(8) inserted into the pressure implementing bar(1) to smoothen up/down movement and return of the pressure implementing bar(1) to the original state, the support(2) to prevent deviation of the pressure implementing bar(1) and the position and displacement sensor(A106) and the pressure sensor(A106) positioned on the support(2). For electromagnetic type, as shown in FIG. 9, responses to pressure signal of the pressure control part(40), transfers voltage to the electromagnet(A102) as a means for magnetic force generation by increasing or decreasing the current, and generates magnetic force in increase or decrease according to increase or decrease in voltage. Then, the resistance object(A200) rises above using resistance against the magnetic field of an electromagnet and it moves up and down according to the received signal, and ultimately it enables each corresponding cell(7) to operate. It is composed of the spring(8) to help up/down movement and return to the original state of the electromagnet(A102), the support(2), the position and displacement sensor(A106) and the pressure sensor(A106) installed in the support(2), and the surrounding tube(A103) not to be magnetized to prevent deviation from the spring, the electromagnet, and the resistance object.

The resistance object(A200) is composed of objects resisting against magnetic force of an electromagnet—superconductor to sensitively react to the magnetic field or permanent magnet. The superconductor is under the condition that resistance disappears completely under certain temperature(named critical temperature) and the magnetic field cannot exist in the inside. In addition to that its electric resistance is 0, it has an important feature magnetically—it is complete diamagnetic(minus effect) that it even push the already intruded magnetic field in the inside before it was formed toward the outside as well as the magnetic field cannot intrude into the inside of the superconductor. Due to this nature, the superconductor shows magnetic levitation that it rises above a magnet. In this invention, the properties of the superconductor are composed to rise or fall by increase or decrease of magnetic force of the electromagnet(A102).//If the resistance object(A200) is composed of the permanent magnet, by applying repulsion of resistance by same poles of the electromagnet(A102), it is composed such that by same poles face the same pole as the electromagnet between +and −, and it makes the resistance object move up and down with magnetic force; if the positive pole of the permanent magnet confronts the electromagnet and magnetic force of the positive pole occurs in the electromagnet by the received signal, the confronted permanent magnet levitates upward and permanent magnets to each cell move up and down from rise or fall of magnetic force after increase or decrease of voltage for the received signal, and then each cell(7) operates to achieve the above object.

Therefore, the electromagnet(A102) achieves the object of the received signal by generating magnetic force according to the received signal and moving up/down the corresponding resistance object that is, each cell. The spring(A103) contracts, falls and then returns to the original state with the internal electromagnet support bar(A105) according to pressure put upon the upper cell—the resistance object(A200). The electromagnet support bar(A105) is connected to the inside of the spring(A103) in the electromagnet, inserted into the support(2), falls according to pressure put upon the cell(7), and then returns to the original state by the spring force, and when it is operated, the resistance object and the electromagnet do not deviate the limited area by the deviation-preventing tube. The deviation-preventing tube(A300) is made to prevent deviation toward all sides when the electromagnet and the resistance object(A200) move up and down, and it is composed of materials not to be magnetized by a magnet.

The support(2) is made to support the spring in up/down movement and return to the original state of each cell(7). Here, the electromagnetic support bar(A105) is inserted to each cell(7) enables up/down movement, and a hole is made to prevent deviation. Same as hydraulic and pneumatic type, the lower bar(25) connected all-in-one with the pressure implementing bar(1) is inserted into the spring and then the support(2), and it enables up/down movement smoothly, prevents deviation and composed to all the cells(7).

The pressure transmitting pump(9) has several types such as hydraulic type, pneumatic type. Specially, for pneumatic type, it involves laying of compressor, and the pressure transmitting medium can be drawn into various forms including oil, air according to the application.

Each cylinder(3) and the pressure transmitting pump(9) of the pressure implementation enabling part(30) can be applied to several types such as hydraulic type and pneumatic type, and various types of the cylinder(3) can also be applied, and the motor(100) of prime mover can be applied.

In addition, not hydraulic and pneumatic type but electromagnetic type of the pressure implementation enabling part(30) enables the received signal to be implemented by increasing and decreasing magnetic force of the electromagnet according to the received pressure signal and moving the touch pad cells(7) up and down from magnetic force or enables pressure to be implemented according to the received signal with motor.

The pressure implementing bar(1) is connected and fixed to the bottom of the cell(7), and spring(8) is inserted into it so that the pressure implementing bar(1) can easily return to the original state after rise or fall. Rise or fall, which is generated by action of the cylinder(3) connected to the pressure transmitting pump(4) and the pressure transmitting tube(5), enables to implement and sense a shape, movement and interaction of an object. The position sensor(A106) attached to the central support(2) senses the cell position and transmits position signal to the cell position sensing part(60). Of course, it can be installed in a proper position of the support(2) or the pressure implementing bar(1) according to the condition.

The spring(8), irrespective of hydraulic and pneumatic type or electromagnetic type of pressure implementing means, plays the same role, and smoothly increases or decreases in implementing the pressure put upon each cell(7) and the received pressure, implements pressure sensing and returns to the original state.

The position and displacement sensor(A106), if the pressure implementation enabling part(30) is electromagnetic type as FIG. 9, shall be formed so that the electromagnet(A102) not be interfered when the position and displacement sensor(A106) installed in the support(2) senses cell position. That is, the position and displacement sensor is selected as laser sensor, a shape shall be formed so that the electromagnet(A102) not be interfered from the light of radiation.

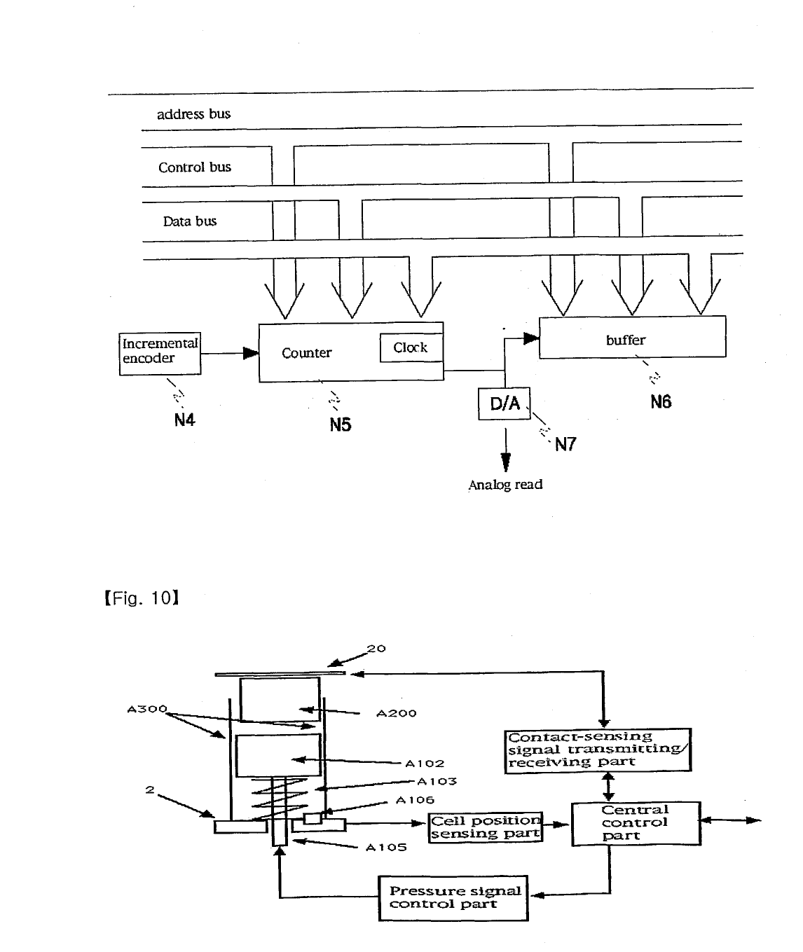

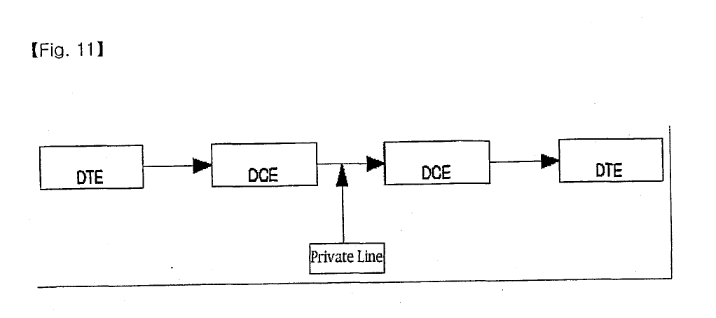

As illustrated in FIG. 10, measuring position data of the cells(7) and converting them into data to be recognizable by the computer is described as follows;

This invention used the enhancement mode optical encoder among position converters. It interfaces the enhancement mode encoder(N4) with the digital microprocessor, detects pulse per revolution of the encoder and measures pulse rise energy and revolving direction. The count value supplied and encoded to the up/down counter made of logic circuit to encode it is read in the microprocessor directly through the input and output circuit without via the A/D converter, and at this time the counted value is transmitted by latchverter. The microprocessor identifies each peripheral device of the measuring system through the address bus, and information is given and received with each peripheral device through the address bus, and start and end of data read, counter clear or buffer clear are controlled by the microprocessor through the user bus.

Therefore, the microprocessor transmits action command to the peripheral device to one direction of the bus and the peripheral device generates control signal so that data not be transmitted to the buffer(N6) from the counter(N5), when the processor reads sampling data through the buffer(N6) in response to the signal to the opposite direction; this guarantees the processor and auxiliary circuit will perform handshake action.

Therefore, data is read by one or more of encode and 3 buses same each other and control is performed, and when position is measured with the enhancement mode encoder, the counter(N5) can be monitored continuously through the D/A converter(N7), and the counter values are read from the microprocessor every sampling moment.

And, as counting values accumulated in measuring displacement are not needed, the buffer(N6) is not cleared until the counting values are read from the processor, and the buffer is read every T period when the speed is measured by the pulse counting method. This period is pertinent to counter—time period. The counter(N5) is cleared whenever a counting value is input from the buffer(N6). In the pulse timing method in measuring speed, the counter operates the timer, and the encoder time is measured with the clock. Then, the counting value is supplied to the buffer(N6) and the counter(N5) is cleared again, starts the next timing period and controls position data of the cell so that the computer recognize them.

Force transducer, motion transducer, and temperature transducer convert each analogue value into digital value and all data-processed to be recognizable by the computer according to features of the device.

As illustrated in FIG. 11, the block diagram is composed of the data transmission unit for the computer system(70,80) to transmit data as follows;

Data Terminal Equipment, called Communication DTE, which converts or processes data into signal, means digital equipment like computer or printer or terminal and has input/output function, data collection and saving function, data processing function and communication function and communication control function. Data Circuit Termination Equipment converts signal processed in Data Communication Equipment(DTE) or signal on communication line, includes modem, LAN, and DSU(Digital Service Unit), and transmits it to telephone line, public network, and RF(Radio Frequency) by transmission line.

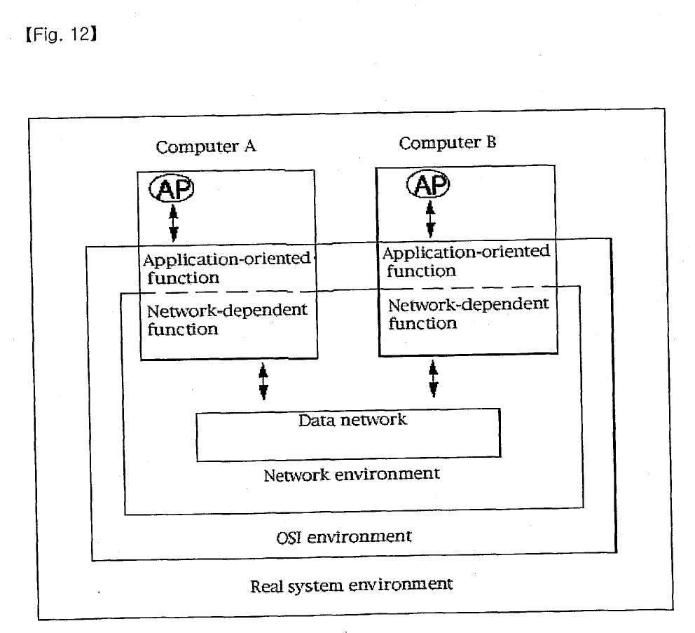

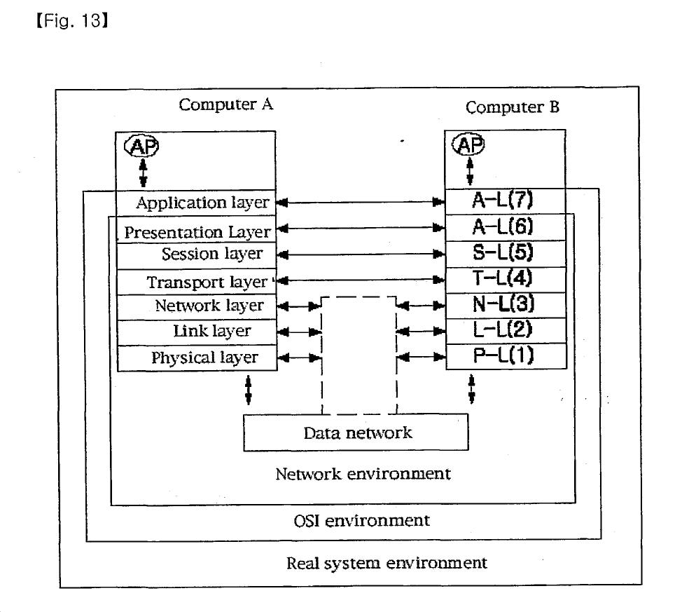

As illustrated in FIG. 12 and FIG. 13, the computer communication model to transmit data of the computer systems(70, 80) is described as follows;

Protocol is used for communication between objects of each different system.//Objects include user application program, file sending package, DB management system, email equipment, and terminal Generally, an object means a thing to be able to transmit and receive information, and system is called a physically independent subject including single object or plural objects. And, they should talk with the same language for successful communication between 2 objects, and what, how and when should they communicate are set and observed through mutually acceptable agreement among related objects—this agreement is called protocol. A group of a series of rules to manage data exchange between two objects is protocol. The crux of protocol is divided into three—syntax, semantic, and timing.

FIG. 12, as a block diagram, illustrates easily as operating environment. Here, computer A and computer B show operating environment including data network and network environment, OSI environment, and real system environment.

The whole architecture of the OSI(Open System Interconnection) model is illustrated in FIG. 13. In Layers confronting each other in FIG. 11, protocols for each level exist, and data goes down from Application Process(AP) to the application layer or the physical layer is transported through data network to the physical layer of the other computer, and then goes up to the application layer and reaches the Application Processor(AP).

Here, OSI environment involves that network environment includes the total 7 layers up to the application layer from the physical layer to the transport layer.

Hereafter, actions of this invention mentioned in the above are described in detail;

First, as illustrated in FIG. 1 or FIG. 3, for the transmitting action of a shape and movement of an object, when a part of human body or any material touches the touch pad(20), information of the object senses signal by the pressure sensor attached on the touch pad contact surface and transmits it to the contact-sensing signal transmitting and receiving part(10). The contact-sensing signal transmitting and receiving part(10) transmits the received pressure signal to the central control part(50). And, the pressure signal, for example, when the user touches his hand on the touch pad contact surface(20) and put pressure onto it, pressure is given to each cell(7) according to unevenness of palm and the pressure signal, which was detected while the pressure implementing bar(1) of the pressure implementation enabling part(30) rises or falls for each cell(7) due to the pressure, is transmitted to the central control part(60) via the contact-sensing signal transmitting and receiving part(10) and cell position sensing part(50). At the same time, when the position sensor(A106) on the support(2) in the center of the pressure implementing bar(1) transmits the position and displacement signal of the pressure implementing bar(1) connected to the cell(7) by pressure to the cell position sensing part(50), the cell position sensing part(50) transmits it to the central control part(60). Pressure and cell position information transmitted like this are connected to the server through the user computer system(70) by communication means like Internet and real-time transmitted to the touch pad system of the remote computer system(80). The received signal on the touch pad contact surface(20) through the touch pad cell of the remote computer(80) is converted, and up/down position and pressure for each cell(7) are implemented by the pressure implementation enabling part(30). It enables the remoter user to see a shape and movement on the touch pad and feel touch from interaction in touching skin.

Next, reversely, the pressure signal is converted in the central control part(60) of the user computer(70) and transmitted to the pressure implementation enabling part(30) via the pressure signal controlling part(40), so that the signal received via the server by Internet from the touch pad system of the remote computer(80) can be transmitted to the central control part(60) of the user computer(70), input into the contact-sensing signal transmitting and receiving part(10) and the pressure signal controlling part(40) according to the information, and then be displayed on the touch pad contact surface(20).

When the pressure implementation enabling part(30) uses hydraulic and pneumatic means by the received pressure signal, it drives the pressure transmitting pump(4) and the pressure transmitting medium transfers pressure to the cylinder(3) via the pressure transmitting tube(5). As the piston of the cylinder for each cell(7) rises or falls by operation of the pressure transmitting pump(4), each pressure implementing bar(1) rise or fall according to a shape and movement of an object, and then those of an object to contact on the touch pad(20) of the remote computer(80) are implemented real-time. //An electromagnet is used as an implementing means, signal transmitted by increasing or decreasing voltage by the received pressure signal and generating magnetic force on the electromagnet(A102) makes the resistance object(A200) move up and down, and the cells(7) operate, and then a shape and movement of an object to contact on the touch pad contact surface(20) of the remote computer(80) are implemented real-time. When the users touch their bodies on the touch pad(20) of the other-side computer(70)(80) interactively, they feel touch by exchanging their shape and movement real-time, and it recognizes how much the cell recognized in the cell position controlling part(50) received pressure that is, how much it was loosened(the feeling level of skin from the pressure put upon the touch pad)//Data communication is always bidirectional, and when pressure is put upon the touch pad at the same time with the remote computer, in what side pressure was put upon more can be controlled by calculating collision of mutual forces, and it is expressed into the following numerical expression as an example.

If the touch pad is used both in the A side and B side, when force 100N applied from the touch pad system in the A side is less than force 200N in the B side, the touch pad operates plus 100N to the touch pad system in the A side.

If force 200N applied from the touch pad system in the A side is over force 100N in the B side, the touch pad operates plus 100N to the touch pad system in the B side.

When force 200N applied from the touch pad system in the A side is equal to force 200N in the B side, same force is collided, so both sides do not operate.

As described in the above, information of pressure transmitted and received of both sides is controlled in the central control part and implemented in the touch pad. Then, a shape and movement of an object are transmitted interactively, movement of the other side is recognized when both sides touch their bodies each other, and the user can feel touch.

The following is a working example and includes several realizable functions to implement more detail information. The heat sensor, flexibility sensor and pressure sensor were attached to help implementation of touch on the touch pad contact surface(20). Signals sensed in the sensors are transmitted to the central control part(60) through the contact-sensing signal transmitting and receiving part(10), and heat information and flexibility information received to the contact-receiving signal transmitting and receiving part(10) through the central control part(60) are implemented on the touch pad surface contact, reversely. The heat information is implemented by the heat implementing unit installed on the touch pad contact surface(20). The inside of the touch pad contact surface(20) is filled with fluid like oil or air to implement fluid flexibility information, and flexibility of a contact object for the remote computer touch pad system(80) also can be implemented. For example, if an object to contact the touch pad(20) is flexible like a ball, flexibility can be implemented if necessary.

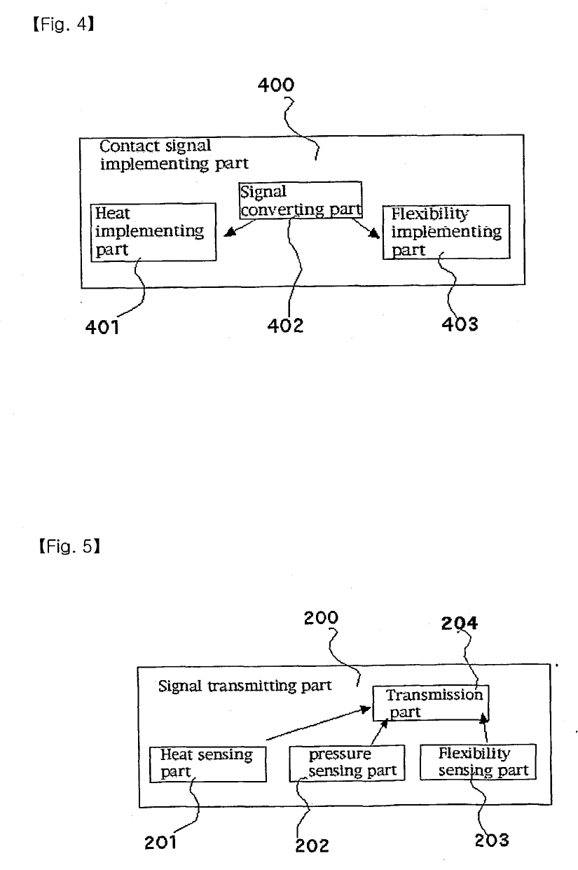

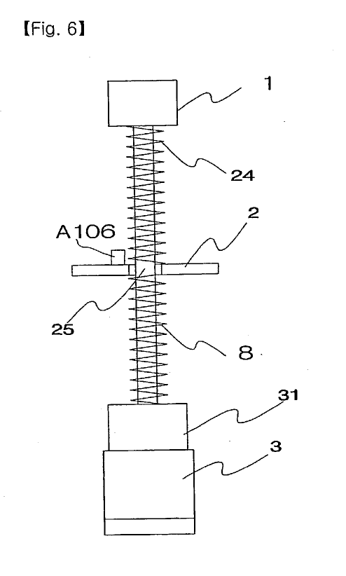

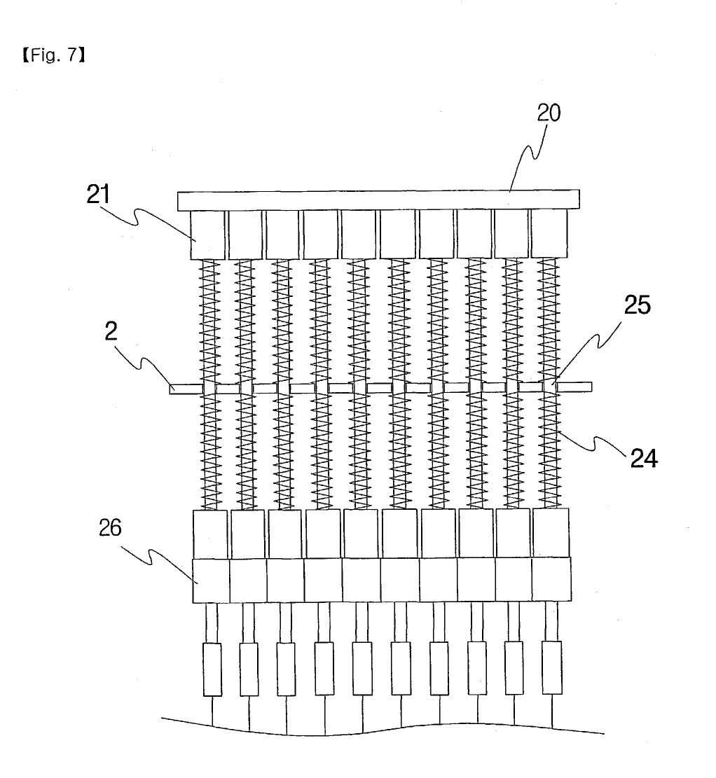

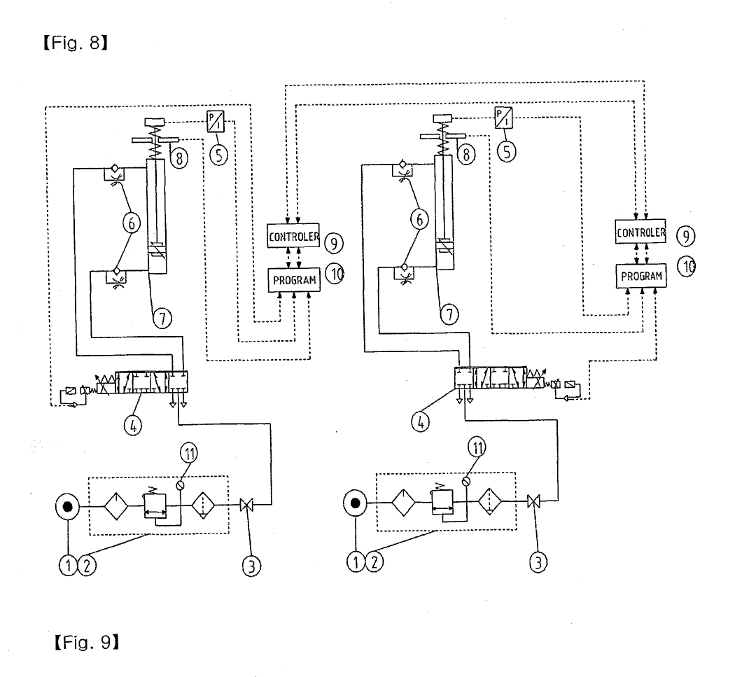

In this case, the contact-sensing signal transmitting and receiving part(10) is composed of the signal transmitting part(200) in FIG. 4 and the sensing-signal implementing part(400) in FIG. 5, and the signal transmitting part is composed of the heat sensor(201), the pressure sensor(202) and the flexibility sensor(203), transmits the converted signal to the central control part(60) through the transmitting part(204). The signal-implementing implementing part(400) is composed of the heat implementing part(401) and the flexibility implementing part(403) and implements the received signal received through the signal converting part(402) on the touch pad contact surface(20). To realize this, the hot wire shall be installed on the touch pad contact surface(20) and the inside of the touch pad contact surface(20) shall have an empty pressure bag to be filled with hydraulic and pneumatic pressure. It can be realized enough with the current technologies, and this will enable information of a contact object to be implemented more finely.

[Industrial Availability]

As described in the above working examples, this invention is applied to various fields; in a hospital, a doctor can perform medical treatment by making a remote patient lie on a big touch pad and touching the shape of the patient shown with his hand; the user can hold a foreign friend's hand joyfully in speaking by telephone with him; and the user can touch products in purchasing them. This invention may make video chatting by communication means like Internet more humanistic through touch and is very effective in various applications including eCommerce, game, communication, virtual reality, military equipment, and remote medical treatment equipment.

1] The touch pad system is characterized by which it is composed of the touch pad cells(7) consisting of small cells with certain size, the touch pad contact surface on the top of the touch pad cell(7) to sense signal of a contacting object, the contact-sensing signal transmitting and receiving part(10) to transmit and receive the sensed signal from the touch pad contact surface(20), the pressure implementation enabling part(30) connected to the bottom of each cells(7) to implement pressure and a shape of an object as an up/down position converting means, the cell position sensing part(50) to control signals of up/down position conversions of the touch pad cells(7), the pressure signal controlling part(40) connected to the pressure implementation enabling part(30) to provide control signal, and the central control part(60) to control signals of the pressure signal controlling part(40), the cell position sensing part(50) and the contact-sensing signal transmitting and receiving(10) and transmit and receive them to and from the computers(70)(80).

2] For claim 1, the touch pad system is featured by which it is composed of the pressure implementation enabling part(30), pressure transmitting pump(9) to convert pressure transmitting media including oil or air into proper pressure and then transmit them to the cylinder(3) allotted to each cell in response to the pressure signal of the pressure signal controlling part(40) as pneumatic and hydraulic type, the motor(100) to drive the pressure transmitting pump(9), the solenoid valve(5) to control flow of the pressure transmitting medium drawn from the pressure transmitting pump(9) according to pressure signal and transfer it to the cylinder, the cylinder(3) to operate by transmission of the pressure transmitting medium transferred from the solenoid valve(5), the flow control valve(4) connected to the rod side of the cylinder(3) to prevent sharp load-change by putting back pressure upon the rod side, the pressure implementing bar(1) connected to the piston of the cylinder(3) to implement designated pressure, the spring(8) inserted into the pressure implementing bar(1) to facilitate up/down movement of the pressure implementing bar(1), the support(2) to prevent deviation of the pressure implementing bar(1), and the position and displacement sensor(A106) and the pressure sensor(A106) on the support(2).

3] For claim 1, the touch pad system is featured by the pressure implementation enabling part(30) of magnetic type, which is composed of the resistance objects(A200) wholly connected to the bottom of the touch pad cells(7), the magnets(A102) corresponding to each resistance object(A200), the spring(A103) to induce the magnets to move up/down and return to the original state, and the sensor(A106) to sense position and pressure of the resistance objects(A200), the tube(A300) to prevent deviation of the magnets(A102) and the resistance objects(A200) in the support(2) to support the magnet. This causes voltage of the pressure signal controlling part(40) by the received signal to increase or decrease, causes each magnet(A102) connected to the pressure signal controlling part(40) to generate magnetic force and increase or decrease it, and then causes the resistance object(A200) against magnetic force to rise or fall.

4] For claim 3, the resistance object(A200) is the touch pad system featuring that it is composed of superconductor and permanent magnet.

5] For claim 1, the touch pad system was implemented to sense information of a contact object on the touch pad contact surface(20), numerically express up/down movement, pressure and sensing information of the touch pad cells(7) according to contact pressure, shape and movement by time units, transmit the data by Internet and network communication to the remote computer system(80) and convert again the data values in the remote computer touch pad system into sensing information, pressure and shape of the contact object.

6] For the above claim 1 and claim 5, the touch pad system is characterized by that it is implemented to interactively send and receive information with the touch pad system of the remote computer in a remote place.
